(19) United States
(12) Patent Application Publication
(10) Pub. No.: US 2021/0183349 A1
(43) Pub. Date: Jun. 17, 2021

(54) REFRACTORY CORE WITH ENHANCED ACOUSTIC PROPERTIES

(71) Applicant: SPL Control Inc., Cambridge (CA)

(72) Inventors: Timothy Wayne Earl Rosenberger, Hamilton (CA); Robin Guy Bennett, Guelph (CA)

(21) Appl. No.: 17/119,362

(22) Filed: Dec. 11, 2020

Related U.S. Application Data
(60) Provisional application No. 62/947,886, filed on Dec. 13, 2019.
(60) Provisional application No. 62/976,431, filed on Feb. 14, 2020.

(51) Int. Cl. G10K 11/168

(52) U.S. Cl. CPC G10K 11/168

(57) ABSTRACT

The disclosure is directed at a refractory core using insulators and noise dampening for use in an exhaust stack. The refractory core includes a framework that includes a plurality of spears that are used to hold insulation segments in place within the framework. The insulation segments includes noise-dampening slots.

### CROSS-REFERENCE TO OTHER APPLICATIONS

The disclosure claims priority from U.S. Provisional Application No. 62/947,886 filed Dec. 13, 2019 and 62/976,431 filed Feb. 14, 2020, both of which are hereby incorporated by reference.

### FIELD OF THE DISCLOSURE

The disclosure is generally directed at incinerators and at gas turbines for industrial and energy utility applications and, more specifically, at insulation and noise dampening using a refractory core with enhanced acoustic properties.

### BACKGROUND

The use of incinerators and gas turbines in industrial applications will be well understood. These devices are typically quite noisy when in use and therefore, there is a need to reduce the noise pollution that is generated by these devices. Typical practice for incinerator silencers is to complete the combustion in a conventional stack, mix in fresh tempering air to lower the gas temperature and silence the new combined gas flow. With many current systems, this would require a complete redesign of either the incinerator or its foundations, neither of which is desirable.

Therefore, there is provided a novel refractory core with enhanced acoustic properties for use in insulation and noise dampening in industrial applications.

### SUMMARY

The disclosure is directed at a refractory core including insulators and noise dampening for use in an exhaust stack. To alleviate some of the problems that may arise using conventional acoustic silencers (i.e. noise dampeners), the disclosure is directed at a system that includes, in one embodiment, a free-standing insulation core made using a framework and stacked insulators which is then inserted into an exhaust stack.

In an embodiment, the disclosure may be seen as a pre-assembled refractory core for use in an acoustic silencer incorporated into an incinerator stack. The refractory core provides silencing inside the walls of the incinerator, retaining inasmuch as possible, the aerodynamic and dispersion characteristics of the incinerator without the integration of the refractory core. In one aspect of the disclosure, there is provided a refractory core with enhanced acoustic properties including a framework; a set of spears having a set of platforms, the set of spears integrated with the framework; and a set of insulation segments resting atop the set of platforms.

In another embodiment, the framework includes at least one circular ring. In a further embodiment, the at least one circular ring includes a plurality of arced segments. The set of spears may be different lengths and different designs. In one embodiment, an end of a spear is inserted through a hole in the framework and then turned to “lock” the spear in place. The set of insulation segments may include noise dampening slots.

In one aspect of the disclosure, there is provided a refractory core with enhanced acoustic properties including a framework including a set of circular rings having a plurality of apertures; a set of spears, the set of spears extending through the plurality of apertures; a set of platforms, each of the set of platforms individually integrated with one of the set of spears; and a set of insulation segments, the insulation segments held in place by the set of platforms.

In another aspect, each of the set of circular rings include a plurality of arced segments that form a circle when placed adjacent each other. In a further aspect, the arced segments are fastened in place by welding, screwing, bolting or pinning. In yet a further aspect, the arced segments are locked in place by at least one of the set of spears. In an aspect, a plurality of the set of platforms are integrated with each spear of the set of spears, the plurality of platforms spaced a predetermined distance apart along each spear.

In yet another aspect, the set of spears form a circle when inserted through the plurality of apertures. In an aspect, platforms integrated with one of the set of spears are staggered with respect to platforms integrated with an adjacent one of the set of spears. In a further aspect, the disclosure includes a casing for housing the refractory core. In another further aspect, the framework is integrated with the casing. In yet another aspect, the insulation segments include noise dampening slots. In a further aspect, the set of spears includes spears having at least two different lengths.

In a further aspect, the set of insulation segments includes layers of insulation segments placed atop each other. In another aspect, the layers of insulations segments are staggered with respect to each other in adjacent layers.

In another aspect of the disclosure, there is provided a refractory core with enhanced acoustic properties including at least two refractory core modules, each of the at least two refractory core modules including: a framework including a set of circular rings having a plurality of apertures; a set of spears, the set of spears extending through the plurality of apertures; and a set of insulation segments, the insulation segments including holes for receiving the set of spears; wherein at least some of the set of spears from one of the at least two refractory core modules extends into the set of insulation segments of another of the at least two refractory core modules to hold the at least two refractory core modules together.

In a further aspect, an end of each of the set of spears further comprise openings for receiving wire to hold the at least two refractory core modules against each other. In yet a further aspect, the disclosure further includes a casing for housing the at least two refractory core modules. In yet another aspect, the disclosure further includes a set of clips for attaching the at least two refractory core modules to the casing.

In another aspect, the disclosure includes a central support for supporting each of the set of spears. In a further aspect, the central support comprises individual tabs for each of the set of spears. In yet another aspect, the central support is integrated with the casing.

### BRIEF DESCRIPTION OF THE DRAWINGS

Embodiments of the present disclosure will now be described, by way of example only, with reference to the attached Figures.

FIG. 1 is a perspective view of a framework for a refractory core;

FIG. 2 is a top view of a platform;

FIG. 3 is a schematic view of a locking portion of a vertical spear;

FIG. 4 is a perspective view of a vertical spear inserted through a circular ring;

FIG. 5 is a view of a refractory core;

FIG. 6a is a top view of an insulation segment;

FIG. 6b is a top view of another embodiment of an insulation segment;

FIG. 7a is a schematic view of a refractory core clip installed in a casing;

FIG. 7b is a perspective view of the refractory core clip;

FIG. 8 is a perspective view of another embodiment of a refractory core module;

FIG. 9 is a side view of a pair of refractory core modules;

FIG. 10 is a perspective view of a pair of refractory core modules;

FIG. 11 is a side view of a refractory core;

FIG. 12 is a perspective view of a refractory core;

FIG. 13a is a top view of an insulation layer;

FIG. 13b is perspective view of an insulation layer;

FIG. 14a illustrates a spear with one type of notch;

FIG. 14b illustrates a spear with another type of notch;

FIG. 15a illustrates a front view of another embodiment of a refractory core;

FIG. 15b is a cross-section taken along line 15b-15b of FIG. 15a;

FIG. 16 is a perspective view of another embodiment of a framework for a refractory core;

FIG. 17 is a perspective view of yet another embodiment of a framework for a refractory core;

FIG. 18 is a perspective view of a further embodiment of a framework for a refractory core; and

FIG. 19 is a top view of an embodiment of a refractory core.

### DETAILED DESCRIPTION

The disclosure is generally directed at a refractory core that is integrated, incorporated or otherwise used within an exhaust stack. In one embodiment, the refractory core may be seen as a combined insulator and acoustic noise dampener. In another embodiment, the refractory core includes at least one framework that includes a set of vertical spears that form a generally circular/cylindrical pattern for housing or receiving segments of insulation, or blanket segments.

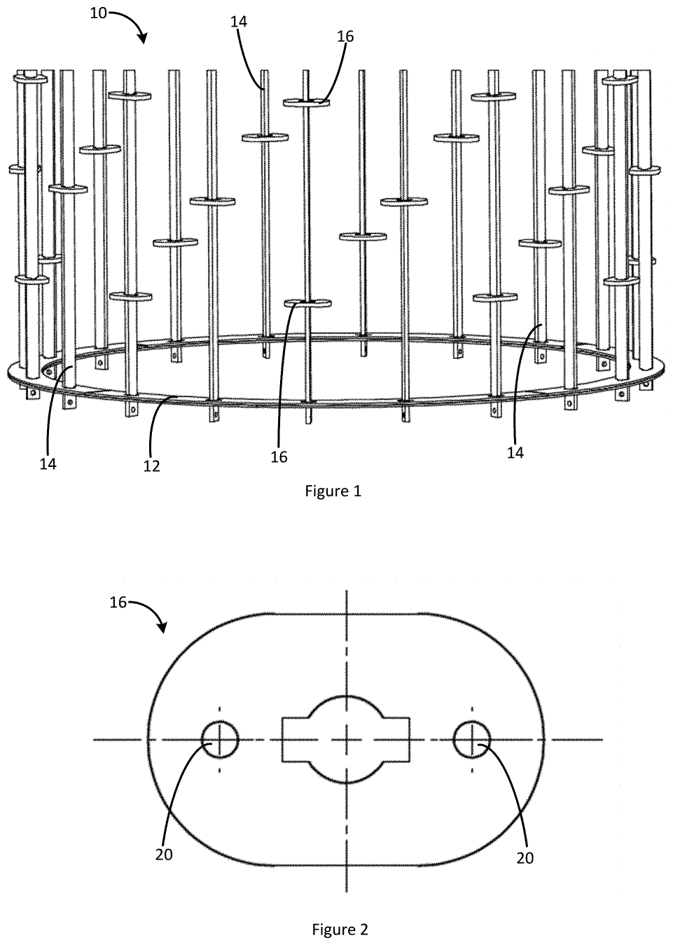

Turning to FIG. 1, a perspective view of a portion of an embodiment of a refractory core, or framework 10, is shown. In some embodiments, the refractory core may be modular and include more than one refractory core module as will be discussed in more detail below.

The framework 10 includes at least one circular ring 12 that receives a set or plurality of vertical spears 14 (via a set of openings), whereby each of the vertical spears 14 includes a set of platforms 16 located at predetermined distances from each other along the vertical spear 14. In other words, the vertical spears 14 may be integrated with the circular ring 12 and the platforms 16 are supported by and/or connected to the vertical spears 14. In some embodiments, each of the set of vertical spears is a same length. Alternatively, within the set of vertical spears, there may be at least two different lengths of spears. An embodiment with two different lengths of spears, seen as a long spear 14a and a short spear 14b is discussed in more detail below. In some embodiments, the at least one circular ring 12 of the framework 10 may include a set of arced segments assembled into a ring, a set of arced segments attached to a casing, a ring attached to a casing, or a set of tabbed portions attached to a casing, as discussed in more detail below.

In some embodiments, each of the set of platforms 16 is a washer that is located a predetermined distance (e.g. approximately 12″) away from an adjacent washer (or platform) on the same vertical spear 14. In other embodiments, the distance between platforms may be varied based on the design and requirements of the refractory core. In the embodiment of FIG. 1, the set of platforms 16 on one spear are staggered with respect to platforms 16 on other vertical spears, however, they may also be aligned with each other depending on a design of the refractory core. Although not shown in FIG. 1, insulation or blanket segments rest atop the platforms or may be held in place by the platforms 16.

In the embodiment illustrated in FIG. 1, the circular ring 12 includes two stacked rows of annular segments joined by the locking action of the spears. The annular segments may be arced segments. Alternatively, the ring may be a single monolithic piece of material, or of annular segments joined by welding, screwing, bolting, pinning or any other conventional fastening system deemed suitable to the particular application.

FIG. 2 provides a top view of an example configuration of one of the platforms. The platform 16 includes a central hole 18 (where the vertical spear 14 passes through) and whereby the platform 16 may rotate with respect to the spear 14 to “lock” the platform in to place. The platform 16 may further include a pair of adjacent holes, or openings, 20 for receiving a tool to assist the process of rotation (such as with respect to the platform and the spear), as needed, depending on the as-fabricated clearance or interference between the central hole 18 and the spear 14.

In some embodiments, the refractory core may be modular, having a plurality of refractory core modules integrated with each other to form the refractory core. The number of refractory core modules may be determined based on criteria such as, but not limited to, height required. In embodiments of the disclosure, the refractory core and the refractory core modules are designed to address thermal expansion problems that are experienced by some current systems. In one embodiment, two refractory core modules are used in order to reduce the likelihood that thermal expansion will become an issue, as it might in a concentrated area using a single elongated refractory core module. While in some embodiments, the sizes of each of the refractory core modules are identical, the sizes of each refractory core module may also be different from each other.

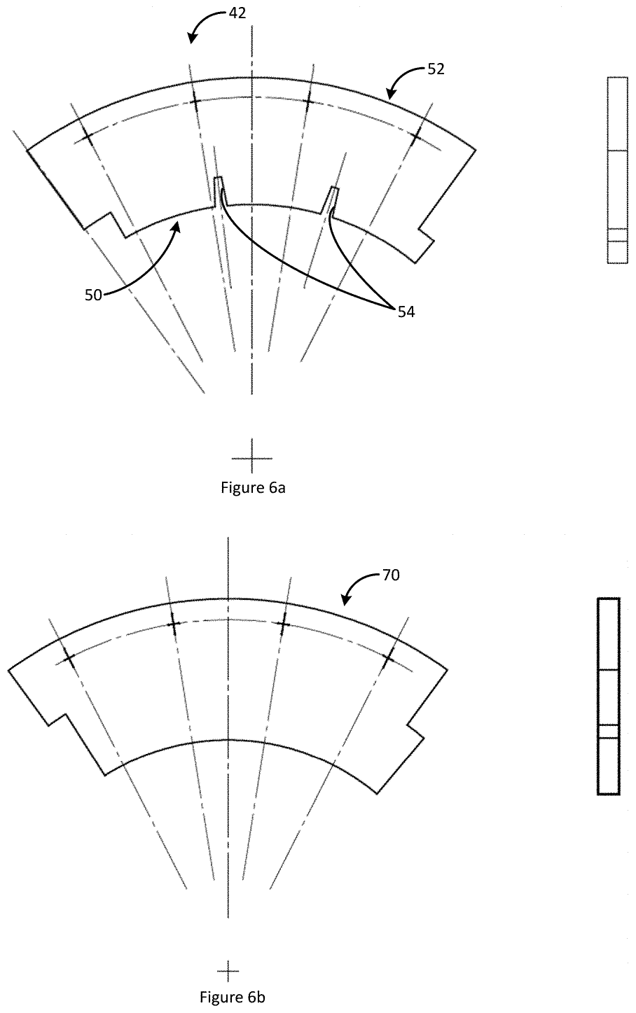

In general, thermal expansion may be intrinsic or extrinsic. With intrinsic expansion, thermal expansion may be experienced by the steel framing (or framework) of the refractory core while, with extrinsic thermal expansion, the expansion is experienced in the components upstream or downstream from the refractory core that it connects to thermally and as a fluid conduit. Embodiments of the disclosure address these thermal expansion issues. In some embodiments, intrinsic thermal expansion may be addressed by the embodiment(s) shown in FIGS. 1 to 6a and 7 and extrinsic thermal expansion may be addressed by the embodiment(s) shown in FIGS. 6b and 8 through 12.

In some embodiments, there is a casing to house the refractory core whether it is a single framework, a pair of refractory core modules or more than a pair of refractory core modules. The casing provides lateral support and location for the refractory core or refractory core modules and may, in some cases, be a structural part of the exhaust stack.

In one embodiment, wherein the refractory core includes two refractory core modules, the long spears 14a of one of the refractory core modules are aligned with the short spears 14b in the other of the refractory core modules. Alignment of the long spears in one of the refractory core modules and the short spears 14b in the other of the refractory core modules assists to accommodate thermal expansion of the spears 14 of framework 10. In some embodiments, the length of the spears are designed to have free space between the tips to accommodate expansion in length to a high or maximum theoretical length.

Furthermore, in order to enable compression of some insulation segments due to the expansion of the spears, a buffer section of insulation material may be installed between the two refractory core modules, such as at a top of the lower refractory core module. This buffer section is preferably not pre-compressed by any platforms, but is left free to compress or expand according to the varying pressure applied to it. When the two refractory core modules are integrated, this buffer section preferably becomes compressed to a low or minimum level. In one embodiment, the buffer section is compressed to around 33%.

Compression due to expansion of the spears may be accommodated by additional compression of this buffer section or middle layer. It will be understood that this buffer section may be thicker than the distance between staggered platforms 16. As a consequence of this buffer layer or section, the spears may be different between the upper and lower refractory core modules and a deviation from the typical platform spacing may be required.

In some initial testing, the stiffness of the compressed buffer layer was sufficient to overcome the self-weight of the top refractory core module. Additional compressive force may be required to install the refractory core in the casing to its correct height depending on the ratio of module weight to cross-sectional area. In the current embodiment, the balance between compression and force due to weight is approximately close to neutral, requiring little additional downward force to complete the insertion of the core into the casing.

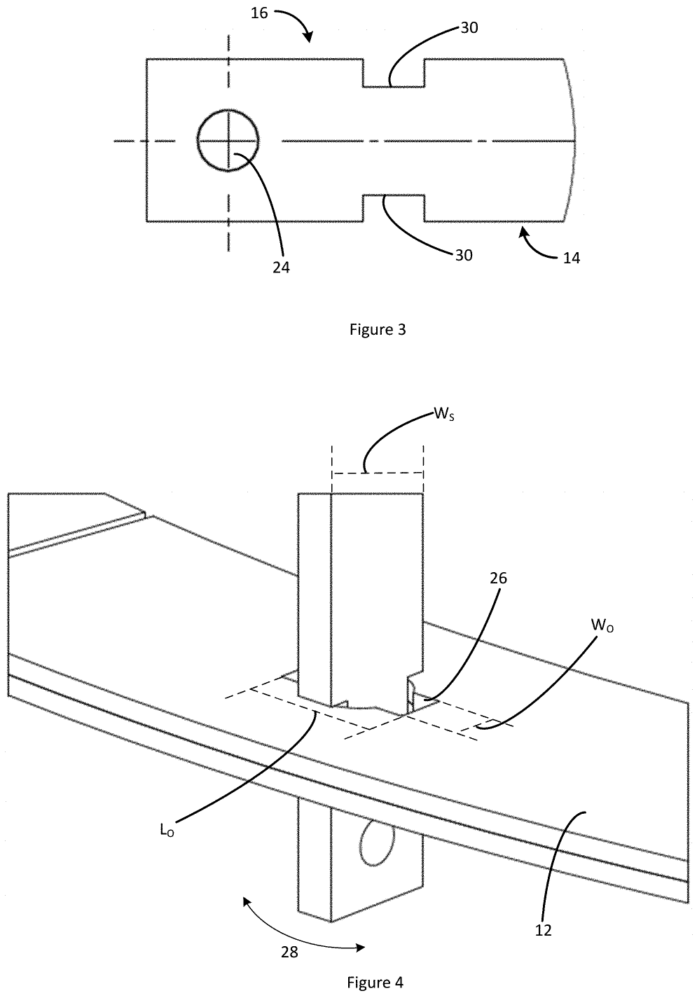

FIG. 3 shows a view of a locking portion of the vertical spear at a point where the circular ring is connected. FIG. 4 shows the same portion of the spear when inserted through the circular ring.

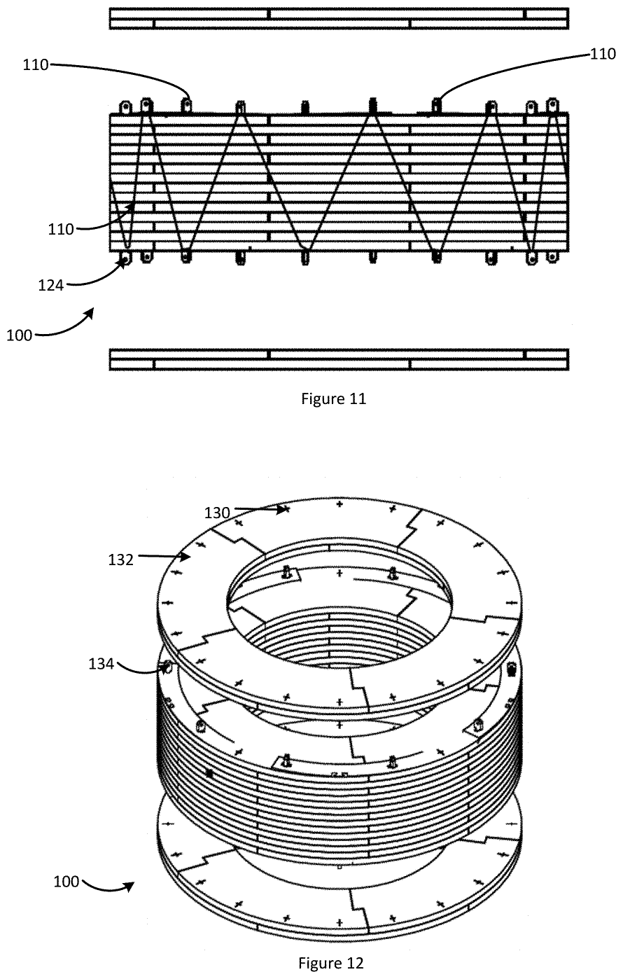

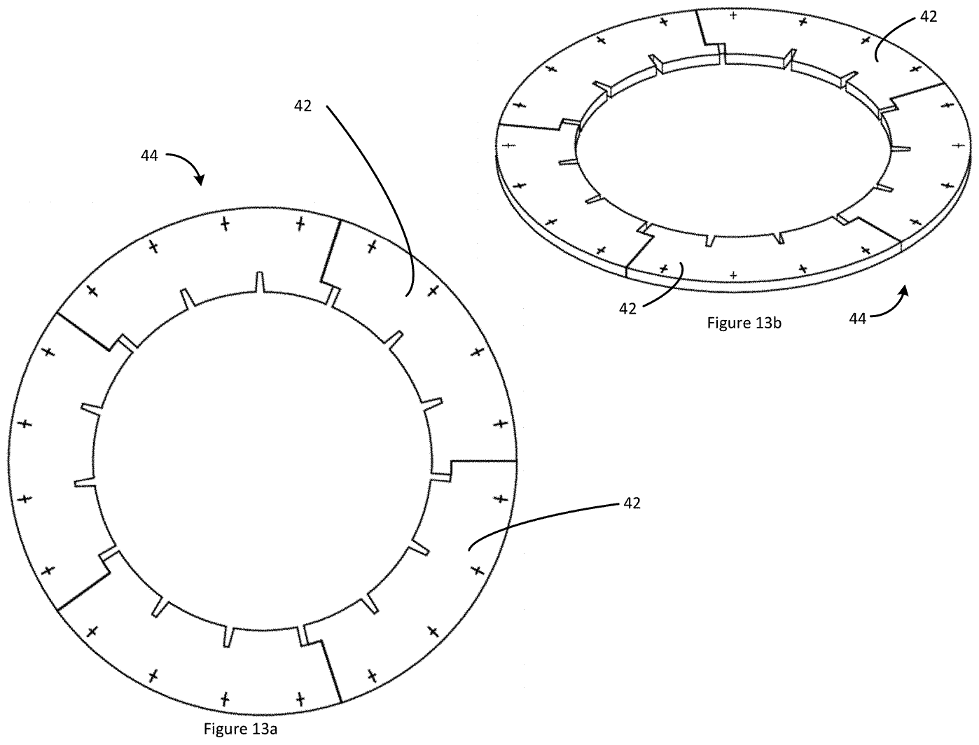

As can be seen in FIG. 3, the locking portion 22 of the vertical spear 14 includes an opening, or hole, 24 and a set of notches 30. In the current embodiment, the locking portion 22 includes a pair of notches 30. The opening 24 may be used to fasten extra ring segments installed on the outside face of the rings 12 particularly as illustrated above and below the stack as shown in FIGS. 11 and 12 by passing a wire down through the insulation segment through the hole 24 and back up.

In FIG. 4, a schematic diagram of the spear twisted in the axial direction is shown. In order to lock the spear 14 within the circular ring, after the spear 14 has been inserted through an opening 26 in the circular ring 12, the spear 14 can be twisted or rotated (about 90 degrees) in an axial direction so that it is placed in a twisted position. Twisting or rotation of the spear is, for example, in the direction of arrow 28. The pair of notches 30 reduce or prevent the likelihood of the spear 14 passing back through the opening 26 after it has been twisted and locked in place. In this embodiment, this locking mechanism avoids the need for welding of the spear 14 to the circular ring 12 which may introduce potential material failure points.

As will be understood, a width, Wₛ, of the spear 14 is somewhat equal to a length, Lₒ, of the opening 26 and greater than a width, Wₒ, of the opening 26.

An advantage of the locking system or locking mechanism, is that it includes protective measures to reduce the likelihood that the spear 14 would slip out of the opening 26 after it has been inserted. One protective mechanism, is that the about 90 degree turn of the spear (enabled by the notches 30) results in the width (Wₛ) of the spear being larger than the width (Wₒ) of the opening. A second protective measure is that the insulation segments are slotted or positioned to prevent or reduce the likelihood of rotation of the spear once they have been installed.

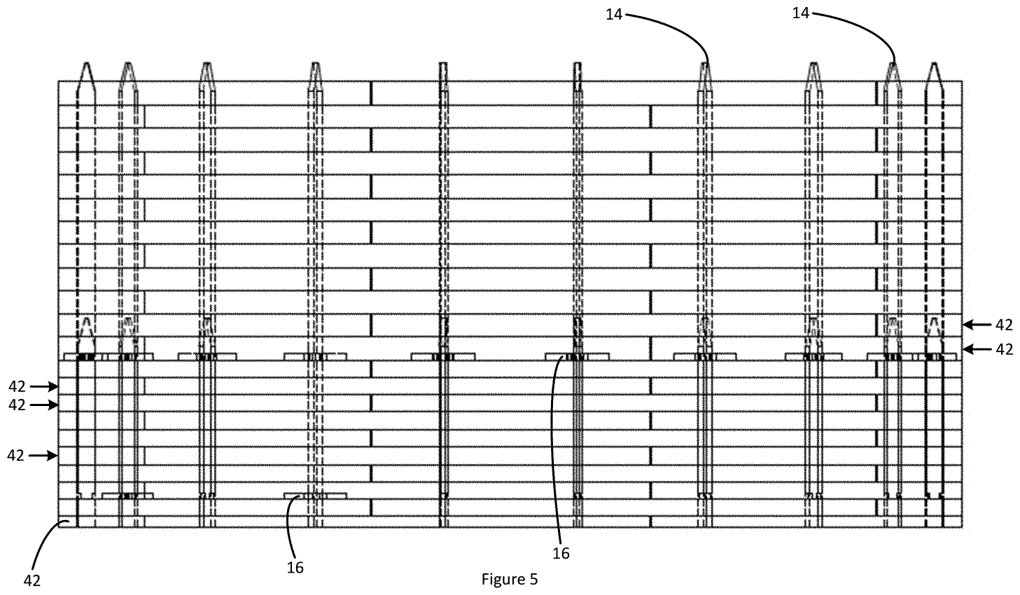

Turning to FIG. 5, a schematic diagram of an embodiment of a refractory core module is shown. As can be seen in FIG. 5, the refractory core module includes the set of spears 14 with each of the spears 14 including a set of platforms 16 spaced a predetermined distance apart along the spear. Resting atop the platforms 16 are a set of blanket insulation segments 42. Each layer 44 of insulation segments 42 includes a plurality of insulation segments placed side by side. Multiple insulation segments are placed adjacent to each other such that an inner portion of the insulation segments forms a circle or arc with the adjacent segments. In some embodiments, the position of the insulation segments 42 in a layer 44 are staggered with respect to a position of the insulation segments in an adjacent layer. In other words, the insulation segments may not be aligned with each other from layer to layer. FIGS. 13a and 13b are top and perspective views of an insulation layer.

In some embodiments, the refractory core includes more than one refractory core module with insulation segments that are stacked atop each other.

As discussed above, in some embodiments, for each refractory core or refractory core module, the set of vertical spears includes long and short spears. In some embodiments, the shorter spear 14b extends from the circular ring a distance that is slightly past its highest platform while the longer spear 14a provides adequate locational support and assists in maintaining uniform compression of the insulation segments of the buffer section.

Individual insulation segments (such as the one schematically shown in FIG. 6a) are placed atop different platforms that receive and support the segments.

As can be seen in FIG. 6a, the insulation segment 42 includes a somewhat circular inner profile 50 that, when placed adjacent other insulation segments in the same layer 44, define a circular shape.

The insulation segment 42 may further include a set of noise dampening slots, or cut-outs, 54 that provide improved silencing and noise dampening compared with current systems. The cut-outs increase the surface area exposed to acoustic energy and thus lead to noise attenuation. The set of noise dampening slots 54 are preferably staggered around a circumference or the inner profile 50 of the insulation segment 42. In one embodiment, the spacing of the slots 54 may be determined based on the wavelength of sound or noise that is being dampened. The spacing may also be determined based on requirements for reducing a turbulence of flow within the exhaust stack.

With current systems, use of at least some types of rigidizing treatment for the insulation tends to close the pores between the fibers in the insulation segments, which degrades or reduces acoustic silencing or noise dampening performance. While the current embodiment uses a rigidizing treatment due to the speed of the gas in the stack, an advantage of the current embodiment is that the interior faces of the noise dampening cutouts 54 will typically not receive significant amounts of rigidizer, thus leaving the pore size of the insulation segment as large as possible, thereby increasing or maximizing the acoustic energy admitted into the insulation. This results in improved noise attenuation.

FIG. 6b provides a schematic diagram of another embodiment of an insulation segment, which may also be seen as an expansion insulation segment. In this embodiment, the expansion insulation segment 70 is placed in an area where the flow is faster and the expansion insulation segment 70 may experience increased compression per cycle than in areas where the flow is not as fast (such as may be experienced by the insulation segment of FIG. 6a). The expansion insulation segment 70 may be more resistant to erosion.

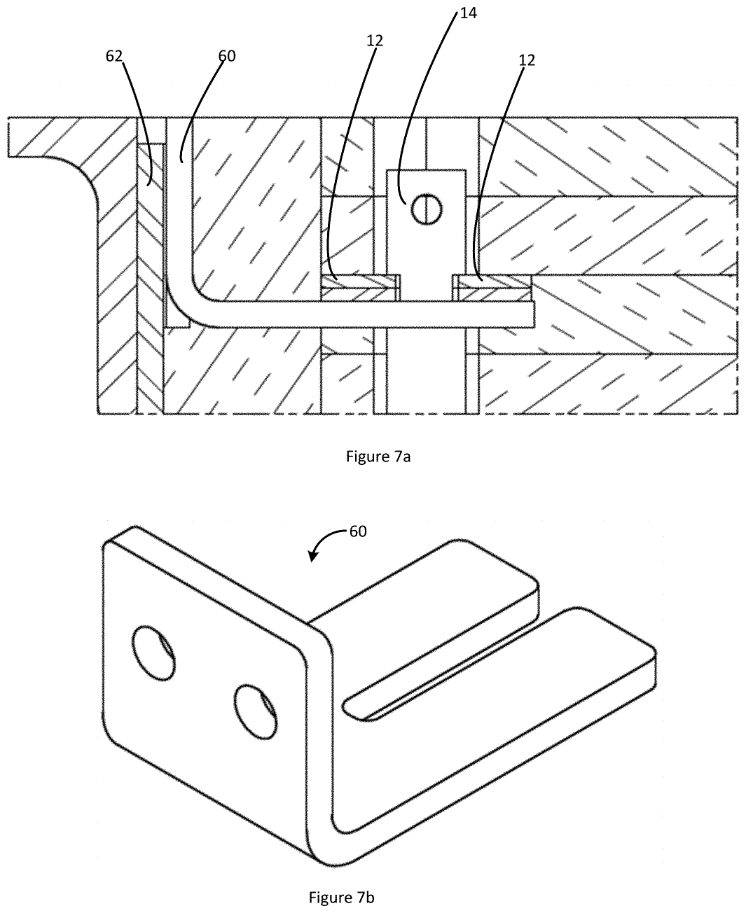

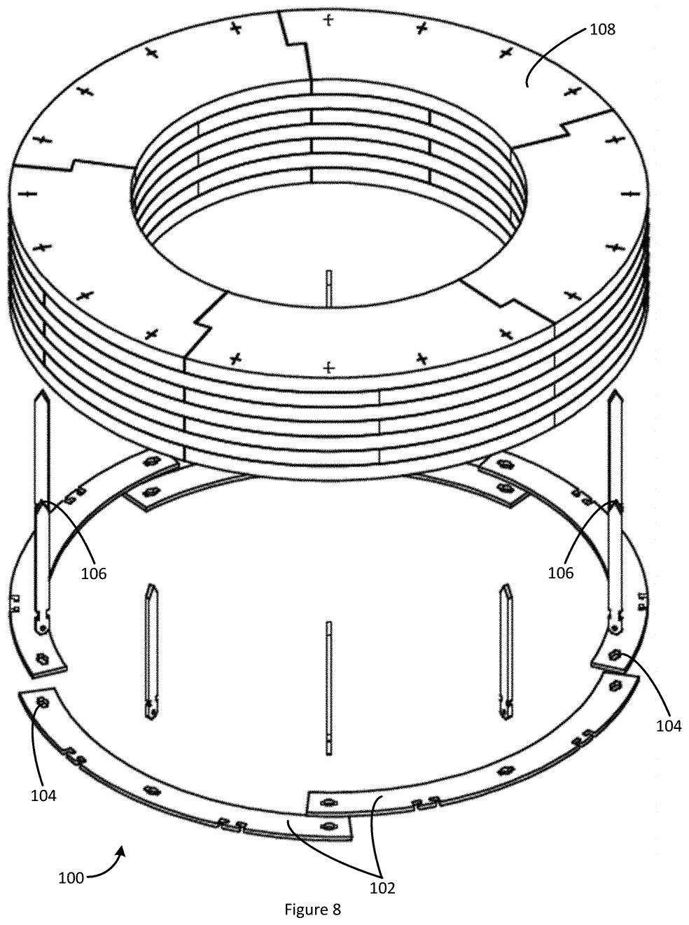

Turning to FIG. 7a, a schematic diagram of a refractory core clip installed in a casing is shown. A perspective view of the clip is shown in FIG. 7b. In a refractory core having more than one refractory core module, over time, one of the refractory core modules (typically the top refractory core module) may settle downward, potentially opening a gap in the insulation near an associated flange. In order to prevent or reduce the likelihood of this happening, the refractory core module may include a set of clips that is attached to the casing holding the two refractory core modules to support at least a portion of the framework of the refractory core module.

As can be seen in FIG. 7a, the clip 60 is installed with one end under a circular ring 12 of the refractory core module straddling a spear with the forked end. The clip is attached at the other end to the casing 62. In a present embodiment, to enable a closer fit between the casing and the refractory core module, the refractory core module may be wrapped with more or increased insulation which is compressed before insertion into the casing and then released to expand. In another embodiment, a thickness of the insulation segment may be changed such that there is little or no compression required before the refractory module is inserted into or attached to the casing.

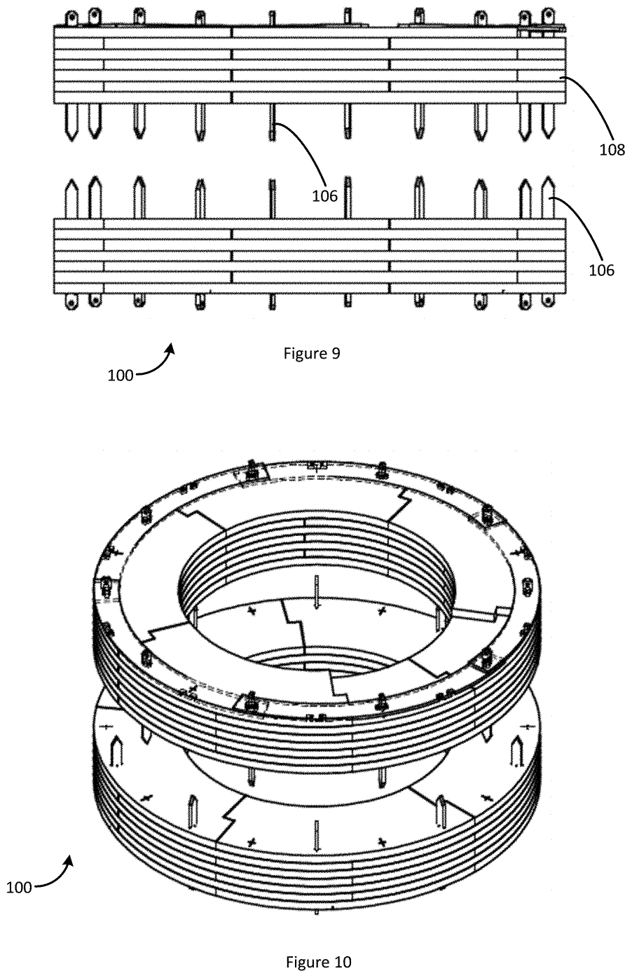

Turning to FIGS. 8 to 12, various perspective and side views of another embodiment of a refractory core are shown. FIG. 8 is a perspective view of a refractory core module 100. The refractory core module 100 includes a circle, or circular, ring 101 that includes a plurality of circle ring segments 102 that form a circle when integrated with each other. In other words, the ring 101 is composed of overlapped circle ring segments 102 that are locked together via a vertical spear 106 (such as disclosed above). In the current embodiment, the circle ring segments 102 are arced segments. The circle ring segments 102 include openings 104 that receive the vertical spears 106.

In the present embodiment, portions of the circle ring segments overlap each other such that a locking end of a vertical spear (such as a longer spear 106a) is placed through the openings 104 of two overlapping segments 102. As described above, an approximate 90 degree axial rotation or twisting of the longer spear 106a after it has been passed through the openings 104 enables the longer spear 106a to be locked in place along with the two adjacent circle ring segments 102. In some cases, shorter vertical spears 106b may pass through a single opening 104 (when the opening is in a middle of the circle ring segment 102) and then locked in place. Alternatively, the positioning of the longer 106a and shorter 106b vertical spears may be switched whereby the shorter vertical spears 106b lock the two adjacent arced segments 102. In another embodiment, the vertical spears may all be the same length such that the vertical spears that are used to lock the two adjacent arced segments 102 are the same length as the vertical spears located in the single opening.

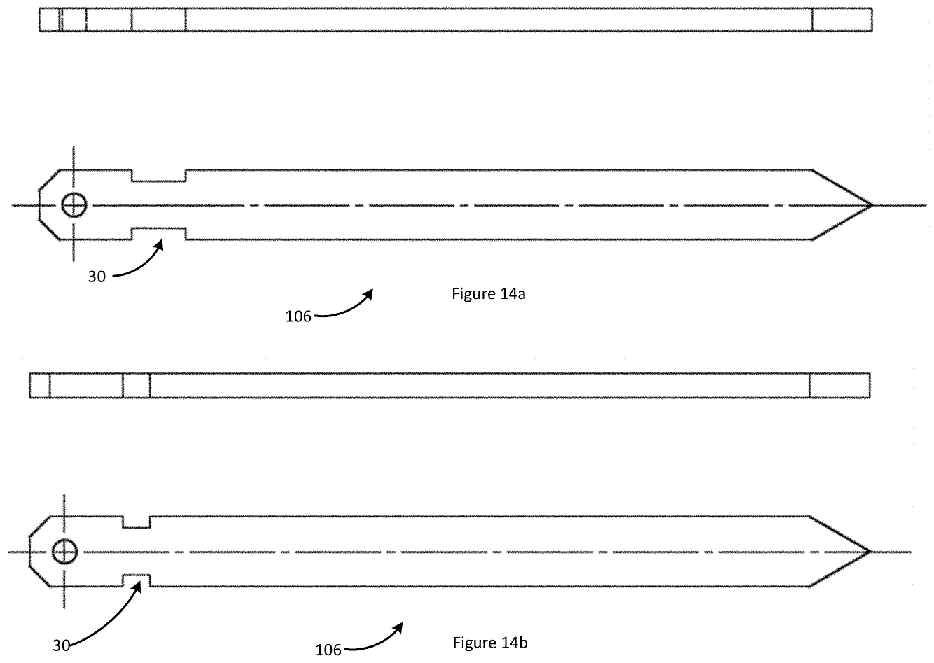

Schematic diagrams of different types of spears are shown in FIGS. 14a and 14b. In the spear of FIG. 14a, the notch 30 is sized to receive or catch a pair of circle ring segments while the spear of FIG. 14b has a notch 30 sized to receive or catch a single ring segment.

After the spears 106 are locked in place and the circular ring “completed”, segments of insulation 108 can then be placed into the refractory core module 100. In some embodiments, the segments of insulation in each layer are aligned with segments of insulation in adjacent layers. Typically, the insulation segments are pushed onto the spears. FIG. 9 is a side view of a pair of refractory core modules 100 prior to being connected or integrated together.

As can be seen in FIG. 10, in some embodiments, each insulation segment 108 is inserted onto or “stabbed” by a spear 106 to assist in keeping the insulation segment in place with respect to the refractory core module 100. In the current embodiment, there are no platforms connected to the spears. In some embodiments, the refractory core modules include insulation segments having twice as many slots for spears as the number of spears in the module. This allows the spears from the other refractory core module to be inserted into the empty slots such as for alignment and for expansion. As can be schematically seen in FIG. 10, the insulation segments 108 in the bottom refractory core module 100 includes openings 130 for receiving spears 106 from the top refractory module.

FIG. 11 is a side view of a pair of connected refractory core modules. In the current embodiment, the two refractory core modules are held together via wire holds 110 after the insulation segments or layers have been compressed. As discussed above, the wire holds may pass through holes or openings 24 in the spears 106. After the refractory core is put together, further insulation segments 132 or layers of insulation may be placed at a top or a bottom of the refractory core to cover the ends 134 of the spears that may be still showing. The further insulation segments may be held in place by the portion of the spears 134 that are still visible. Turning to FIG. 12, a perspective view of FIG. 11 is provided.

In an alternative embodiment, shorter casings may be contemplated to reduce the need for separate floating refractory core modules.

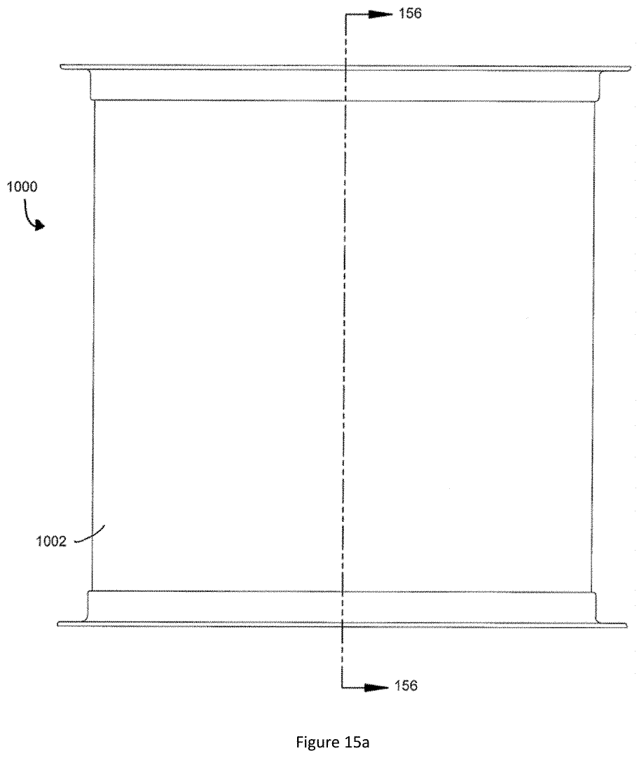

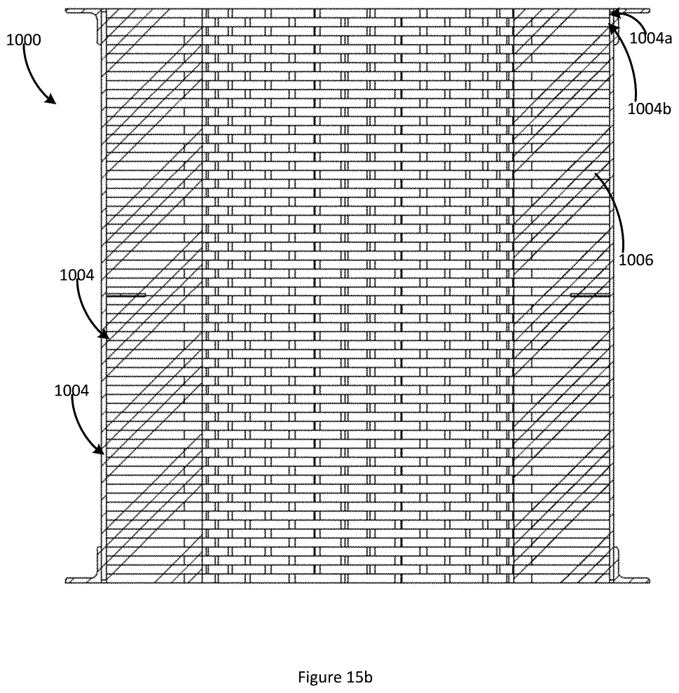

Turning to FIG. 15a, a front view of another embodiment of a refractory silencer core is shown. In the current embodiment, the refractory core 1000 includes a casing 1002. Turning to FIG. 15b, which is a cross-sectional view taken along line 15b-15b of FIG. 15a, the refractory core 1000 includes a plurality of layers 1004 of insulation segments 1006. In the current embodiment, adjacent layers 1004a and 1004b are staggered with respect to each other.

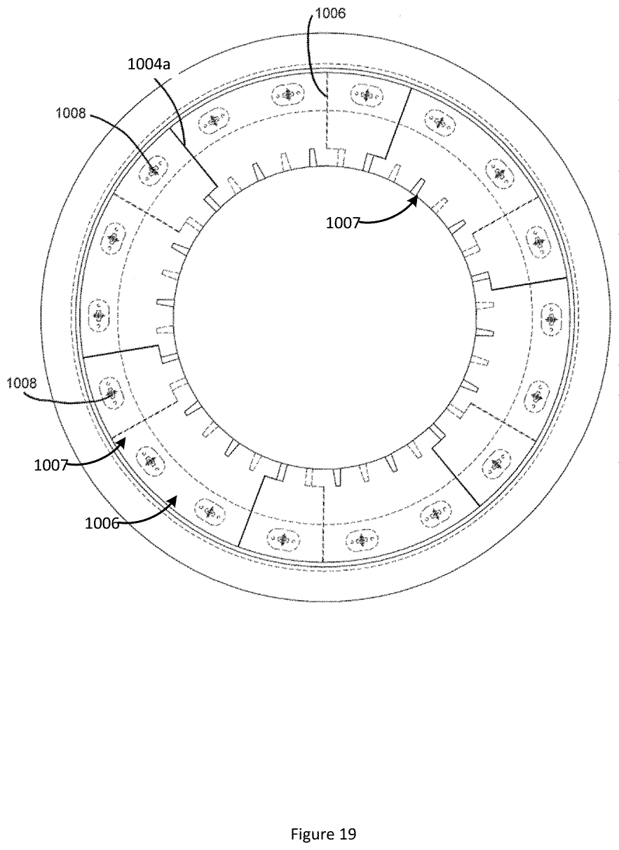

Turning to FIG. 19, a top view of the refractory core of FIG. 15 is shown. FIG. 19 provides a schematic view of how the insulation segments may be staggered with respect to each other within the refractory core. In FIG. 19, the insulation segments 1006 in the first, top or closest layer 1004a of insulation segments 1006 are shown in solid lines while the insulation segments 1006 of the adjacent layer 1004b are shown in dotted lines. In the current embodiment, the insulation segments in layer 1004b are flipped with respect to the insulation segments 1006 in layer 1004a to provide the staggered positioning of the notches 1007 between layers. The insulation segments are held in place by spears 1008 such as described above.

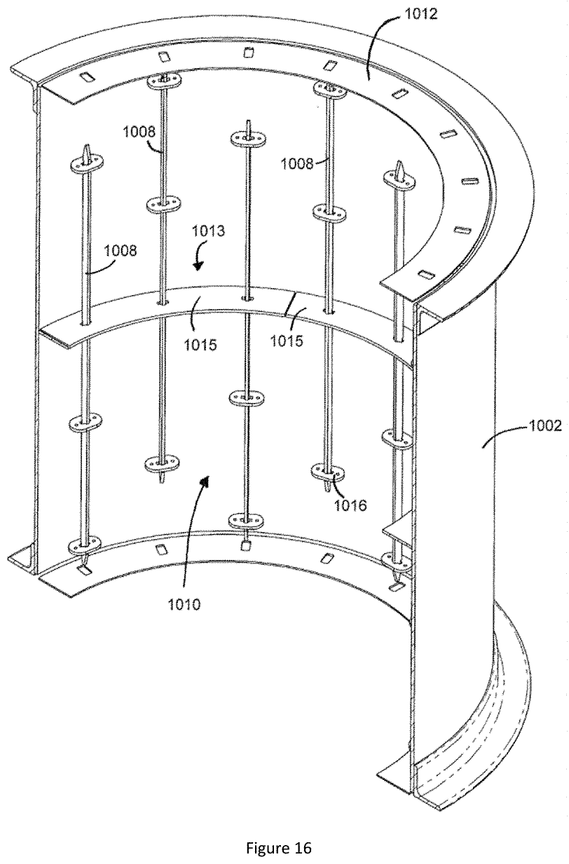

Turning to FIG. 16 a perspective view of a half portion of an embodiment of a framework for the refractory core is shown. The framework 1010 is connected to, mounted to, or integrated with, the casing 1002. Typically, the complete framework 1010 is circular in shape.

In the current embodiment, the framework 1010 of FIG. 16 includes a set of circular end rings 1012. In other embodiments, the end rings may be separate from the framework 1010. Typically, the end rings 1012 act as retainers to reduce the likelihood or to prevent the insulation segments from falling out of the framework, or casing, during shipping and handling, however, depending on the refractory core set-up, the set of end rings 1012 may also be for receiving and holding a set of spears 1008 in place. The set of circular end rings 1012 may be a single piece ring or may be made up of arced segments that form a circle when placed side by side.

The circular end rings 1012 include a set of holes for receiving the spears 1008. In one embodiment, the spears 1008 may not initially extend through the holes but may do so due to thermal expansion of the spears 1008. In another embodiment, some of the spears 1008 may initially extend through at least one hole in an end ring and be locked in place. One method of locking a spear in place is discussed above.

The framework 1010 further includes a support, or central support, ring 1013 located between the two end rings 1012 for supporting the set of spears 1008. In the current embodiment, the support ring 1013 is spatially located in the middle between the two end rings although the position of the support ring 1013 may be in any location between the end rings 1012. In the current embodiment, the support ring 1013 is made up of arced segments 1015 that form a circle when placed side by side.

The spears 1008 are preferably pointed at each end to pierce through the insulation segments when they are layered within the framework 1010 (such as shown in FIG. 15b). As with some embodiments above, support platforms 1016 are located at predetermined positions along the spears 1008 to provide further support to, or to hold the insulation segments when they are placed within the framework or refractory core. In one embodiment, the spears 1008 are locked to the support ring 1013 similar to the manner discussed above. The platforms 1016 may or may not be mounted or integrated with the casing.

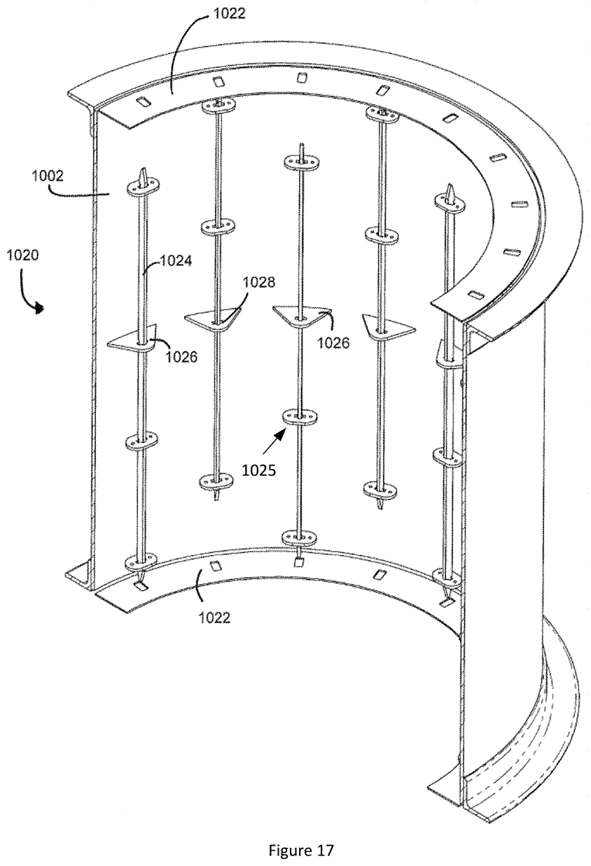

Turning to FIG. 17, a perspective view of a portion of another embodiment of a framework for the refractory core is shown. As with the embodiment of FIG. 16, the framework 1020 is connected to, or integrated with, the casing 1002. In some embodiments, the framework 1020 may be manufactured separated from the casing and may simply be placed within an existing casing.

The framework 1020 of FIG. 17 includes a set of circular end rings 1022 located at opposite ends of the framework 1020. As discussed above, the end rings 1022 may or may not be part of the framework 1020 depending on the design or requirements of the refractory core. The circular end rings 1022 include holes for receiving ends of spears 1024 such as disclosed above. The framework 1020 further includes central, or tabbed, support portions 1026 that are mounted, or attached, to the casing 1002 such that the tabbed portions 1026 may be seen as being integrated with the casing 1002. Each of the central portions 1026 include an opening, or hole, 1028 for receiving a spear 1024. One of the functionalities of the central portions 1026 is to house a portion of the spears to guide and/or support the spears 1024. As can be seen, in the current embodiment, the spears 1024 are identical with points at both ends and have a length along a long axis of the spears 1024 that is shorter than a height of the refractory core. The height of the refractory core may be seen as the length of the refractory core parallel to the long axis of the spears 1024. Although not shown, it is understood that the central portions 1026 continue around the inside of the entire circular casing or framework. The framework may also include platforms 1025 which may or may not be mounted or integrated with the casing 1020.

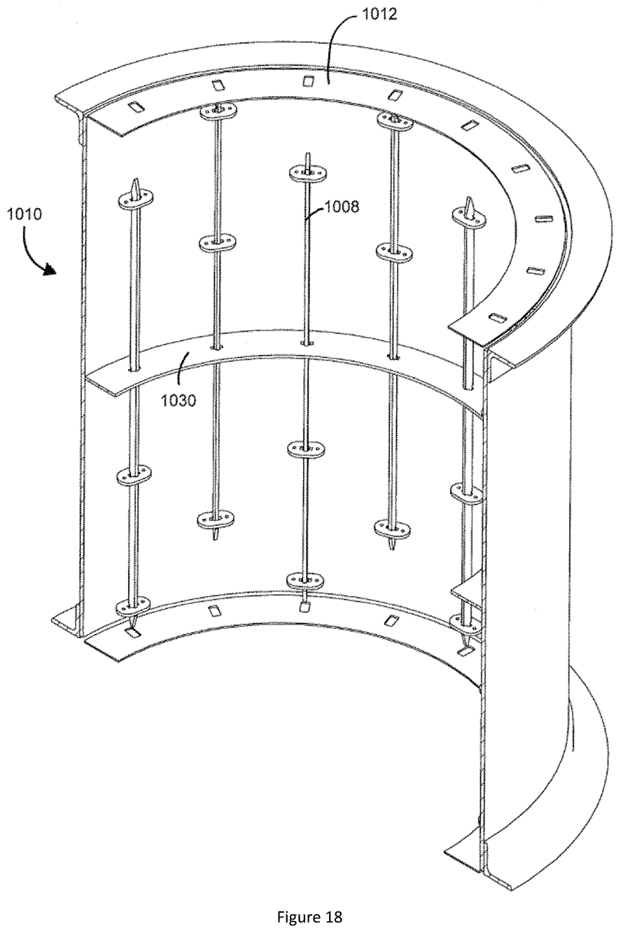

Turning to FIG. 18, a perspective view of a portion of another embodiment of a framework for the refractory core is shown. The embodiment of FIG. 18 is similar to the embodiment of FIG. 16 with the difference being the support ring 1030. In the current embodiment, the support ring 1030 is a single circular piece. In one embodiment, the support ring 1030 is mounted to the inside of the casing such that it stays in place when the refractory core is installed within an incinerator. The support ring 1030 performs the same functionality as the support ring 1013 of FIG. 16.

As with the embodiment of FIG. 16, the framework includes end circular rings 1012 that receive the ends of spears 1008 due to thermal expansion and/or to lock the spears in place.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

1. A refractory core with enhanced acoustic properties comprising:
a framework including a set of circular rings having a plurality of apertures;
a set of spears, the set of spears extending through the plurality of apertures;
a set of platforms, each of the set of platforms individually integrated with one of the set of spears; and
a set of insulation segments, the insulation segments held in place by the set of platforms.

2. The refractory core of claim 1 wherein each of the set of circular rings comprise a plurality of arced segments that form a circle when placed adjacent each other.

3. The refractory core of claim 2 wherein the arced segments are fastened in place by welding, screwing, bolting or pinning.

4. The refractory core of claim 2 wherein the arced segments are locked in place by at least one of the set of spears.

5. The refractory core of claim 1 wherein a plurality of the set of platforms are integrated with each spear of the set of spears, the plurality of platforms spaced a predetermined distance apart along each spear.

6. The refractory core of claim 1 wherein the set of spears form a circle when inserted through the plurality of apertures.

5. ractory core of claim 5 wherein platforms integrated with one of the set of spears are staggered with respect to platforms integrated with an adjacent one of the set of spears.

8. The refractory core of claim 1 further comprising a casing for housing the refractory core.

9. The refractory core of claim 1 wherein the framework is integrated with the casing.

10. The refractory core of claim 1 wherein the insulation segments comprise noise dampening slots.

11. The refractory core of claim 1 wherein the set of spears comprises spears having at least two different lengths.

12. The refractory core of claim 1 wherein the set of insulation segments comprise layers of insulation segments placed atop each other.

13. The refractory core of claim 12 wherein the layers of insulations segments are staggered with respect to each other in adjacent layers.

14. A refractory core with enhanced acoustic properties comprising:
at least two refractory core modules, each of the at least two refractory core modules including:
a framework including a set of circular rings having a plurality of apertures;
a set of spears, the set of spears extending through the plurality of apertures; and
a set of insulation segments, the insulation segments including holes for receiving the set of spears;
wherein at least some of the set of spears from one of the at least two refractory core modules extends into the set of insulation segments of another of the at least two refractory core modules to hold the at least two refractory core modules together.

15. The refractory core of claim 14 wherein an end of each of the set of spears further comprise openings for receiving wire to hold the at least two refractory core modules against each other.

16. The refractory core of claim 14 further comprising a casing for housing the at least two refractory core modules.

17. The refractory core of claim 16 further comprising a set of clips for attaching the at least two refractory core modules to the casing.

18. The refractory core of claim 8 further comprising a central support for supporting each of the set of spears.

19. The refractory core of claim 18 wherein the central support comprises individual tabs for each of the set of spears.

20. The refractory core of claim 18 wherein the central support is integrated with the casing.
